(19) United States
(12) Patent Application Publication
(10) Pub. No.: US 2004/0173980 A1
(43) Pub. Date: Sep. 9, 2004

(54) Foldable telescope golf cart having a balancing mechanism

(76) Inventor: David Yang, Moraga, CA (US)

Correspondence Address: DAVID YANG, 1020 WICKHAM DR., MORAGA, CA, 94556, US

(21) Appl. No.: 10/376,704

(22) Filed: Mar. 3, 2003

(51) Int. Cl. B62B 1/00

(52) U.S. Cl. 280/47.26

(57) ABSTRACT

A swing arm assembly in accordance with the present invention is used as a balancing mechanism for the foldable telescope golf cart. The swing arm assembly adjusts the inclined position of the golf beg on the golf cart, and thus adjusts the center gravity location of the cart assembly. By selecting a proper length and rotational angle of the swing arm, it is possible to position the center gravity of the cart assembly in line with the centerline of the cart wheels at all time during cart traveling. The swing arm assembly is operated by linkages that enable the assembling of the entire cart assembly, including the cart frames, wheels, and particularly the swing arm assembly, from a compact storage size to a full service size, or vice versa, by a single action of pulling the upper cart frame.

### BACKGROUND OF THE INVENTION

A foldable telescope golf cart has been commonly used by golfer for carrying golf beg. A foldable telescope golf cart is characterized by its fold ability to a compact storage size. In prior art, the cart typically has an upper cart frame and a lower cart frame, which are pivotally jointed in order to facilitate conversion of the cart between a compact storage size and a full service size. The conversion of the cart normally requires a single action of pulling the upper cart frame. FIG. 1 and FIG. 2 represent a full service size of a foldable telescope golf cart of prior art, in an up-right standing position and an inclined traveling position respectively. FIG. 1 and FIG. 2 also illustrate a well-known fact that the center gravity (c. g.) of the cart moves from “behind of the wheels” to “before of the wheels”, as the cart being converted from the standing position to the inclined traveling position. Consequently, golfer is subject to a portion of the cart weight during pulling the cart.

In U.S. Pat. No. 5,667,239, I claimed an adjustable balancing mechanism for the foldable telescope golf cart. The principal element of the previously claimed balancing mechanism is a swing arm, which has one end pivotally connected to the lower cart frame, and another end fixedly connected to a golf beg saddle. As illustrated in FIG. 3 and FIG. 4, the swing arm supports the golf beg in an angular position so that the center gravity (c. g.) of the cart is positioned in line with the centerline of the wheels. Such alignment maintains the cart in a balanced state in the inclined traveling position. As a result, golfer is no longer subject to a portion of the cart weight, which significantly reduces the stress level experienced by golfer during pulling the cart.

However, there is a drawback of my previously claimed balancing mechanism in U.S. Pat. No. 5,667,239. The drawback is that golfer needs to take an extra step to assemble the balance mechanism, after assembling the cart from the compact storage size to the full service size, or vice versa. Therefore, there is a need to improve my previously claimed balancing mechanism in U.S. Pat. No. 5,667,239. The improved balancing mechanism shall allow a single pulling of the upper cart frame to complete the assembling of the entire cart assembly, including the cart frames, wheels, and particularly the balancing mechanism.

### OBJECTS AND SUMMARY OF THE INVENTION

The object of the present invention is to provide a foldable telescope golf cart with a balancing mechanism, which allows the center gravity (c. g.) of the cart to be positioned in line with the center line of the wheels at all time during traveling.

Another object of the present invention is to provide a foldable telescope golf cart with a balancing mechanism, which is foldable to allow the entire cart assembly to be folded to a compact size for storage or transportation.

Another object of the present invention is to allow the entire cart assembly, including the cart frames, wheels and balancing mechanism, to be simultaneously assembled from a compact storage size to a full service size, or vice versa, by a single action of pulling the upper cart frame.

In accordance with the present invention, new linkages are added to the balancing mechanism. The objects of these linkages are as follows: (1). When the upper cart frame rotates toward the lower cart frame, i.e., to assemble the cart to a compact storage size, linkages shall cause the swing arm of the balancing mechanism to rotate toward the lower cart frame. Both the upper cart frame and the swing arm shall simultaneously reach their final positions in adjacent to and in parallel to the lower cart frame. (2). When the upper cart frame rotates away from the lower cart frame, i.e., to assemble the cart to a full service size, linkages shall cause the swing arm to rotate away from the lower cart frame. When the upper cart frame is ultimately aligned to the lower cart frame in a final position, the swing arm shall simultaneously reach its final position, i.e., a predetermined angular position for maintaining the cart in a balanced state in the inclined traveling position. (3). Linkages shall provide a locking means to securely lock the swing arm in its final position.

### BRIEF DESCRIPTION OF THE DRAWINGS

FIG. 1 is an isometric view of a foldable telescope golf cart of prior art in a standing position, illustrating the center gravity (c. g.) of the cart assembly being positioned “behind” the centerline of wheels.

FIG. 2 is an isometric view of a foldable telescope golf cart of prior art in an inclined traveling position, illustrating the center gravity (c. g.) of the cart assembly being positioned “before” the centerline of wheels, which requires an external force for balancing the cart.

FIG. 3 is an isometric view of a foldable telescope golf cart having the previously claimed balancing mechanism of U.S. Pat. No. 5,667,239, illustrating the center gravity (c. g.) of the cart assembly being positioned “behind” the centerline of wheels in a standing position.

FIG. 4 is an isometric view of a foldable telescope golf cart having the previously claimed balancing mechanism of U.S. Pat. No. 5,667,239, illustrating the center gravity (c. g.) of the cart assembly being positioned in line with the centerline of wheels in an inclined traveling position. Consequently, there is no external force required for balancing the cart.

FIG. 5 is an elevation view of a foldable telescope golf cart having the improved balancing mechanism of the present invention, wherein the cart is shown in a full service size.

FIG. 6 is an elevation view of a foldable telescope golf cart having the improved balancing mechanism of the present invention, wherein the cart is shown in a compact storage size.

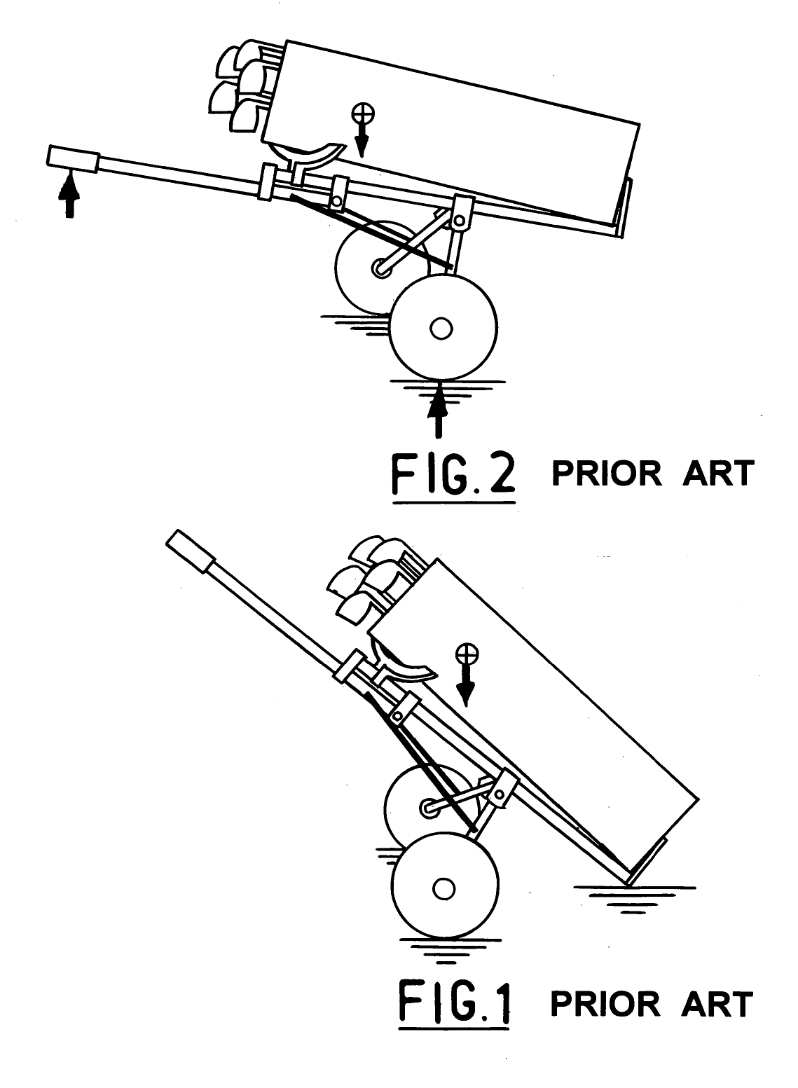

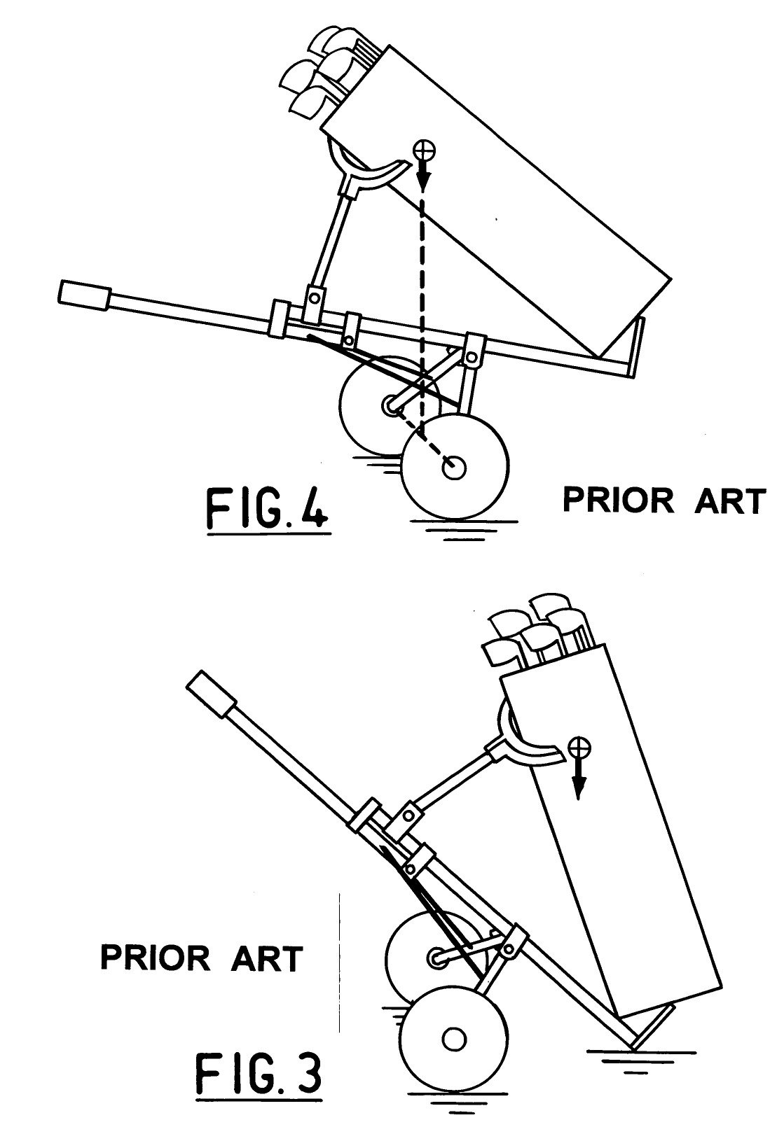

### DETAILED DESCRIPTION OF PREFERRED EMBODIMENTS OF THE INVENTION

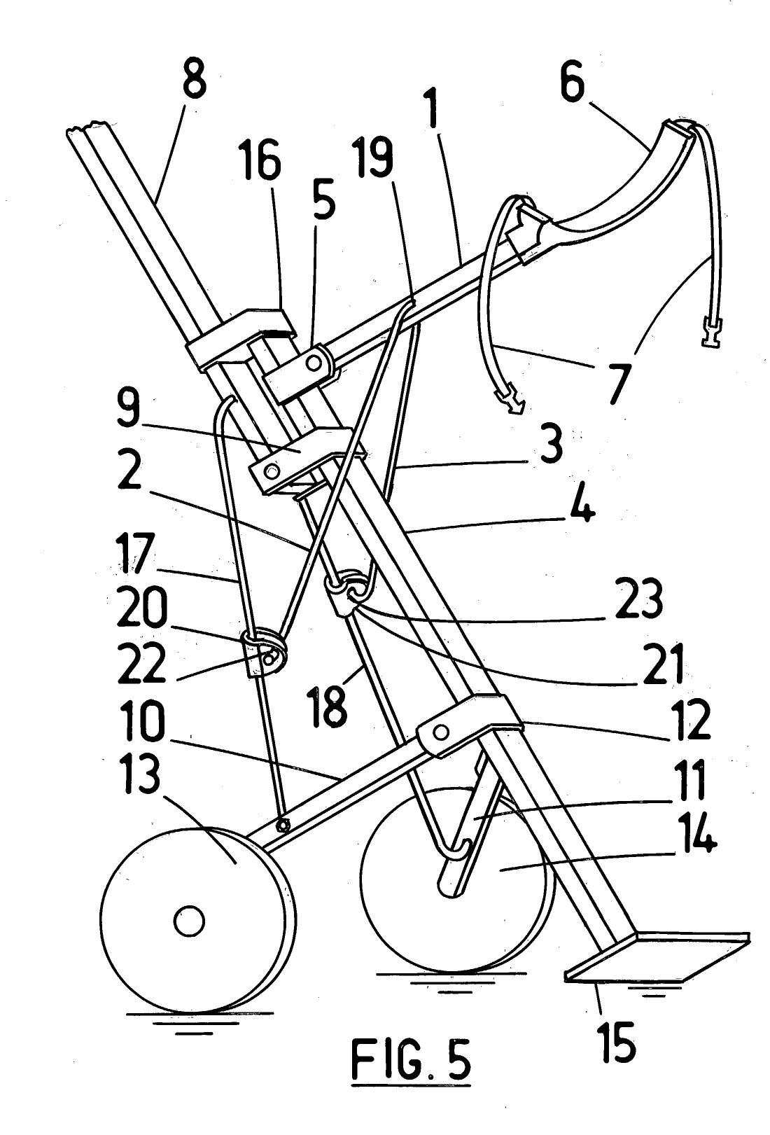

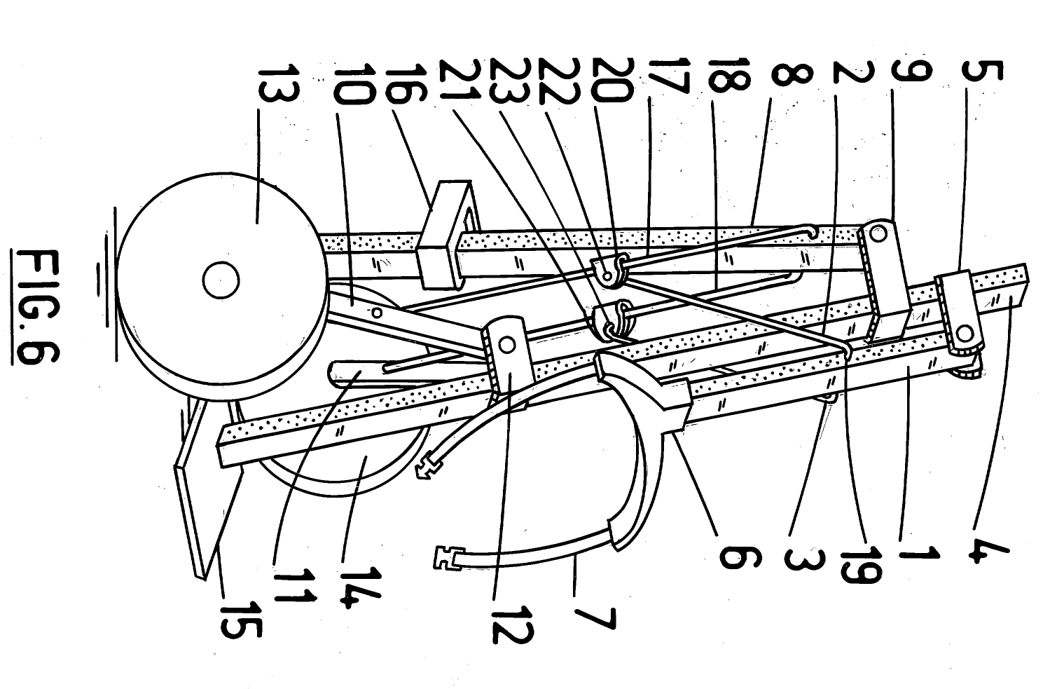

FIG. 5 and FIG. 6 represent a foldable telescope golf cart having the improved balancing mechanism of the present invention. It is understood that the improved balancing mechanism of the present invention is intended to be adopted by a variety of foldable telescope golf cart of prior art. FIG. 5 and FIG. 6 are not intended to show in details the existing embodiments of the foldable telescope golf cart of prior art, nor the variety in existing embodiments of the foldable telescope golf cart of prior art. Variations in existing embodiments of the foldable telescope golf cart represented by FIG. 5 and FIG. 6 are considered within the scope of the present invention, provided that variations have no effects to the functionality of the improved balancing mechanism as disclosed by the present invention.

As shown in FIG. 5 and FIG. 6, the distinguished elements of the improved balancing mechanism of the present invention consist of a swing arm 1, and a pair of connecting rods 2 and 3. One end of the swing arm 1 is pivotally connected to a lower cart frame 4 by a mounting bracket 5. Another end of the swing arm 1 is connected to a golf beg saddle 6, which has a seat belt 7 for securing a golf beg to the saddle 6. As the golf beg being secured and seat belt 7 being locked, swing arm 1 can no longer rotate freely.

The golf cart shown in FIG. 5 and FIG. 6 has an upper cart frame 8, which is pivotally connected to the lower cart frame 4 by a mounting bracket 9. The upper ends of wheel frames 10 and 11 are pivotally connected to the lower cart frame 4 by a mounting bracket 12. The lower ends of wheel frames 10 and 11 support wheels 13 and 14 respectively. A support bracket 15 is mounted at the lower end of lower cart frame 4 for supporting the golf beg. A sliding bracket 16 is mounted to the upper cart frame 8, which locks the upper cart frame 8 to the lower cart frame 4 as the cart being assembled to the full service size. Connecting rods 17 and 18 provide linkages between the upper cart frame 8 and wheel frames 10 and 11 respectively. It has been well known in prior art that connecting rods 17 and 18 enable the assembling of the cart from a compact storage size to a full service size, or vice versa, by a single pulling action of the upper cart frame 8.

In accordance with present invention, the connecting rods 2 and 3 serve as rotational linkages between the swing arm 1 and connecting rods 17 and 18 respectively. Each of the upper ends and lower ends of connecting rods 2 and 3 consist of a short radius bend. Each of the upper ends of connecting rods 2 and 3 penetrates a through hole 19 in mid section of swing arm 1, which forms a rotational joint at each of the upper ends of connecting rods 2 and 3. Rod fittings 20 and 21 are fixedly mounted in mid section of connecting rods 17 and 18 respectively. The lower ends of the connecting rods 2 and 3 penetrate through holes 22 and 23 in rod fittings 20 and 21 respectively, which form rotational joints at the lower ends of the connecting rods 2 and 3. Alternatively, the lower ends of connecting rods 2 and 3 are threaded so that nuts can be installed to prevent slippage of connecting rods 2 and 3. It is understood that rod fittings 20 and 21 can be in various forms. Alternatively, they can be constructed as integral parts of connecting rods 17 and 18.

Connecting rods 2, 3, 17 and 18 are interconnected “linkages” to perform the followings objects: (1). When the upper cart frame 8 rotates toward the lower cart frame 4, i.e., to assemble the cart to a compact storage size (FIG. 6), “linkages” cause the swing arm 1 to rotate toward the lower cart frame 4. Ultimately, the upper cart frame 8 and the swing arm 1 simultaneously approach their final positions, which are in adjacent to and in parallel to the lower cart frame 4. (2). When the upper cart frame 8 rotates away from the lower cart frame 4, i.e., to assemble the cart to a full service size (FIG. 5), “linkages” cause the swing arm 1 to rotate away from the lower cart frame 4. Ultimately, as the upper cart frame 8 is aligned to the lower cart frame 4 in the final position, the swing arm 1 simultaneously approach its final position, i.e., a predetermined angular position for maintaining the cart in a balanced state in the inclined traveling position. (3). “Linkages” serve as locking means for securely locking the swing arm 1 in its final position.

It is understood that a variety of linkages can be used for achieving the objects as described above. It is not the intent of the present invention to claim all possible linkages for achieving the objects as described above. For example, connecting rods 2 and 3 can be alternatively configured to become direct linkages between the swing arm 1 and wheels frames 10 and 11. Wherein, the lower ends of connecting rods 2 and 3 penetrate through holes provided in mid section of the wheel frames 10 and 11 respectively. For another example, connecting rods 2 and 3 can be alternatively configured to become first linkages between the swing arm 1 and a sliding bracket mounted on the lower cart frame 4. Wherein, additional connecting rods are added as second linkages between the sliding bracket and connecting rods 17 and 18, or alternatively, between the sliding bracket and wheel frames 10 and 11. For another example, connecting rods 2 and 3 can be integrated into one continuous rod. Therefore, linkages different from the preferred embodiments shown in FIG. 5 and FIG. 6 are considered within the scope of the present invention, provided that linkages are to perform the objects as disclosed by the present invention.

It is also understood that synthesis of linkages may yield different results, such as different dimensions of linkages based on different configuration or geometry of the cart. For example, it is often necessary to first select the locations of rotational joints to avoid interference with free rotation of the connecting rods. Consequently, dimensions of linkages, including the lengths or shapes of linkages can be different. It is not the intent of the present invention to claim all possible results. Therefore, dimensions of linkages, or locations of connecting joints different from the preferred embodiments shown in FIG. 5 and FIG. 6 are considered within the scope of the present invention, provided that linkages perform the objects as disclosed by the present invention.

What is claimed is:

1. A balancing mechanism and method for maintaining a foldable telescope golf cart in a balanced state in an inclined traveling position, wherein the cart assembly, including a golf beg and golf clubs, being in the balanced state provided the center gravity of the cart assembly, hereinafter referred as c.g. of the cart assembly, being in line with a centerline of cart wheels; said balancing mechanism adjusting position of said c.g. of the cart assembly by means of rotating the golf beg on the golf cart, enabling adjustment of an incline angel of the golf beg during cart traveling, wherein a decrease in the incline angel of the golf beg shifting said c.g. of the cart assembly toward the front side of the golf cart, and resulting an increase in a horizontal distance between said c.g. of the cart assembly and said centerline of the cart wheels; wherein an increase in the incline angel of the golf beg shifting said c.g. of the cart assembly toward the rear side of the golf cart, and resulting a decrease in a horizontal distance between said c.g. of the cart assembly and said centerline of the cart wheels; and
Said balancing mechanism to be adopted by a foldable telescope golf cart comprising of: an upper cart frame, a lower cart frame, a pair of wheels and associated wheel frames, a first pair of connecting rods, a first, second, third, and fourth mounting bracket; said upper cart frame being pivotally connected to said lower cart frame by a first mounting bracket; said wheel frames being pivotally connected to said lower cart frame by a second mounting bracket; said first pair of connecting rods serving as linkages between said upper cart frame and said wheel frames; said third mounting bracket being mounted at a lower end of said lower cart frame for supporting a golf beg; said fourth mounting bracket being mounted to said upper cart frame, capable of locking or unlocking said upper cart frame to said lower cart frame during assembling the golf cart for service, or disassembling the golf cart for storage; and
Said balancing mechanism comprising of a swing arm, a saddle, a seat belt, a fifth mounting bracket, and a second pair of connecting rods; said swing arm having one end pivotally connected to said lower cart frame by said fifth mounting bracket, and another end connected to said saddle for supporting the golf beg, wherein said seat belt securing the golf beg to said saddle; said balancing mechanism being operated by linkages provided by said second pair of connecting rods, which enabling the entire golf cart assembly, including said balancing mechanism, being converted from a compact storage size to a full service size, or vice versa, by a single action of pulling said upper cart frame; said upper cart frame, said wheel frames and said swing arm being simultaneously rotated toward said lower cart frame as the golf cart being converted to said compact storage size, wherein said upper cart frame, said wheel frames and said swing arm being ultimately positioned in adjacent to and in parallel to said lower cart frame; said upper cart frame, said wheel frames and said swing arm being simultaneously rotated away from said lower cart frame as the golf cart being converted to said full service size, wherein said upper cart frame being ultimately locked to and aligned with said lower cart frame, and said swing arm being ultimately in an angular position capable of maintaining the golf cart in the balanced state during cart traveling.

2. The balancing mechanism of claim 1 wherein said second pair of connecting rods provide linkages between said swing arm and said first pair of connecting rods.

3. The balancing mechanism of claim 1 wherein said second pair of connecting rods provide linkages between said swing arm and said wheel frames.

4. The balancing mechanism of claim 1 wherein said second pair of connecting rods provide linkages between said swing arm and said lower cart frame.

5. The balancing mechanism of claim 1 wherein said second pair of connecting rods are made of a single continuous rod.

6. The balancing mechanism of claim 1 wherein the upper end of each of said second pair of connecting rods is bent horizontally, which penetrates a through hole in mid section of said swing arm, and forms a rotational joint.

7. The balancing mechanism of claim 2 wherein the lower end of each of said second pair of connecting rods is bent horizontally, which penetrates a through hole in a rod fitting, and forms a rotational joint.

8. The balancing mechanism of claim 3 wherein the lower end of each of said second pair of connecting rods is bent horizontally, which penetrates a through hole in mid section of each of said wheel frames, and forms a rotational joint.

9. The balancing mechanism of claim 4 wherein the lower end of each of said second pair of connecting rods is bent horizontally, which penetrates a through hole in a sliding bracket mounted on said lower cart frame, and forms a rotational joint.

10. The balancing mechanism of claim 7 wherein said rod fitting is mounted to each of said first pair of connecting rods, which has a feature preventing said rod fitting from sliding.

11. The balancing mechanism of claim 7 wherein said rod fitting is constructed as an integral part of each of said first pair of connecting rods.

12. The balancing mechanism of claim 9 wherein a third pair of connecting rods are added, which provide linkages between said sliding bracket and said first pair of connecting rods.

13. The balancing mechanism of claim 9 wherein a third pair of connecting rods are added, which provide linkages between said sliding bracket and said wheel frames.
